(19) United States
(12) Patent Application Publication
(10) Pub. No.: US 2003/0072707 A1
(43) Pub. Date: Apr. 17, 2003

(54) Process for aqueous phase oxidation of sulfur or sulfide to thiosulfate, bisulfite or sulfite ions using air

(76) Inventors: Michael F. Ray, Canyon Lake, TX (US); Mark C. Anderson, Spring, TX (US)

Correspondence Address: GREENLEE WINNER AND SULLIVAN P C, 5370 MANHATTAN CIRCLE, SUITE 201, BOULDER, CO, 80303, US

(21) Appl. No.: 10/184,020

(22) Filed: Jun. 26, 2002

Related U.S. Application Data
(60) Provisional application No. 60/301,534, filed on Jun. 27, 2001.

(51) Int. Cl. C01B 17/64

(52) U.S. Cl. 423/514

(57) ABSTRACT

A method is provided for producing thiosulfate from oxidation of reduced sulfur species without producing elemental sulfur and without converting more than 9% of the sulfur species to sulfate ion. The method consists essentially of oxidizing a thiosulfate solution with an oxidizing agent to produce a partially oxidized solution, adjusting the pH of the partially oxidized stream to between 5 and 8; and contacting the partially-oxidized solution with a stream containing a reduced sulfur species so that the reduced species is oxidized and the partially-oxidized stream reduced.

### CROSS-REFERENCE TO RELATED APPLICATIONS

This application takes priority from U.S. provisional application serial No. 60/301,534, filed Jun. 27, 2001, which is hereby incorporated by reference to the extent not inconsistent with the disclosure herewith.

### BACKGROUND OF THE INVENTION

The present invention relates generally to two classes of processes, those used for removing H₂S from a gas stream and recovering the sulfur, and those for production of thiosulfate. Numerous processes have been described for absorbing H₂S from gas or liquid streams into a liquid phase and oxidizing it to elemental sulfur. In general, these processes involve scrubbing the H₂S-containing gas with a liquid phase wherein metal ions such as iron or vanadium or other compounds soluble in the liquid phase, such as anthroquinone disulfonic acid, in a higher oxidation state oxidize the sulfide to elemental sulfur and are themselves reduced to a lower oxidation state. U.S. Pat. No. 4,830,838 discloses a method for converting hydrogen sulfide to elemental sulfur using a polyvalent metal chelate. Chelating agents are used to increase the solubility of the metal ions. The aqueous phase is then transferred to an oxidizing zone where the metal ions or other compound are reoxidized to the higher oxidation state using air. The elemental sulfur is separated by flotation. The function of the metal ion or oxidizing compound is to oxidize the sulfide to elemental sulfur while limiting the oxidation potential of the scrubbing solution to prevent oxidation of sulfide to higher oxidation states, such as thiosulfate, bisulfite, sulfite, and sulfate, which are much more soluble in the solution and whose accumulation in the solution must be limited by either discarding a portion of the scrubbing solution and replacing it with fresh solution, incurring substantial cost for both disposal and replacement, or by regeneration.

Several patents describe processes for regenerating the scrubbing solution. U.S. Pat. No. 6,180,080 discloses a method for removing thiosulfates from Stretford solution using peroxygen compounds, producing sulfur. U.S. Pat. No. 5,380,442 uses a catalyst to convert sulfur compounds from used Stretford solution (containing thiosulfates and sulfides) to sulfate salts, which are precipitated so that the metal chelate may be reused. U.S. Pat. No. 3,959,452 acidifies a slipstream of scrubbing solution to decompose the thiosulfate to elemental S and SO₂, which are removed by flotation and stripping, respectively, then raises the pH of the solution and returns it to the Stretford process. U.S. Pat. No. 4,364,918 reduces the cost of regeneration by concentrating the thiosulfate by precipitating it with nickel ethylene diamine, separating the precipitate by filtration, and transferring it to a regeneration zone where the thiosulfate is decomposed with acid to elemental sulfur and SO₂ and the nickel ethylene diamine is regenerated by addition of lime and returned to the Stretford process. Recognizing that the presence of some concentration of thiosulfate in the scrubbing solution reduces the rate of degradation of the chelated metal catalyst, U.S. Pat. No. 6,083,472 describes a process by which the concentration of thiosulfate in the scrubbing solution can be controlled by modulating the division of the feed stream containing H₂S between two processes, one in which H₂S is scrubbed according to the process described above and the other in which a portion of the feed gas is scrubbed with an alkaline solution.

U.S. Pat. No. 4,871,520 discloses a process to remove hydrogen sulfide from a gas stream and convert it to elemental sulfur by oxidizing it with ammonium iron chelates, maintaining a low concentration of thiosulfate to prevent degradation of the chelate molecule. U.S. Pat. No. 4,083,945 discloses a process for treatment of hydrogen sulfide containing gas streams with alkaline washing solution (such as sodium carbonate) to form sulfide which is then oxidized to elemental sulfur, while inhibiting the formation of thiosulfate by adding an aldehyde to the washing solution. In the processes described, the reaction whereby sulfide is oxidized to thiosulfate is recognized as a side reaction that produces an undesirable by-product.

The second class of process relating to the present invention is the intentional production of thiosulfate. Processes have been described to produce aqueous solutions of ammonium thiosulfate (ATS) by reacting a solution of ammonium sulfites with sulfur in solid or liquid form, or with sulfides or polysulfides typically in aqueous solution, as described in Kirk-Othmer Encyclopedia of Chemical Technology, 4th edition, 1997, vol. 24, page 62, and in U.S. Pat. Nos. 2,412,607; 3,473,891; 3,524,724 and 4,478,807. The process of U.S. Pat. No. 3,431,070 produces ATS in a continuous process from gaseous feed streams comprising H₂S, NH₃ and SO₂.

U.S. Pat. No. 5,543,122 discloses a method for converting hydrogen sulfide to thiosulfate and residual bisulfite and/or sulfite by splitting the H₂S-containing gas stream into two streams, oxidizing one gas stream by combustion to convert the H₂S to SO₂, absorbing the SO₂ into an aqueous phase to produce an aqueous stream of sulfite, reacting the second gas stream with a solution of ferric chelate to convert the H₂S to elemental sulfur, separating the sulfur from the ferric chelate solution, and reacting said elemental sulfur with an excess of the sulfite stream to produce thiosulfate.

U.S. Pat. No. 6,159,440 discloses a method to absorb SO₂ in an aqueous NH₃ solution to form ammonium hydrogen sulfite and then reacting that solution with additional NH₃ and H₂S to produce concentrated solution of ammonium thiosulfate. The SO₂ for the process is generated outside of the process and may require burning of sulfur or H₂S if an external source is not available. This process differs from the Coastal process primarily in that part of the ammonia required is supplied to the process in a feed stream which is a mixture of ammonia and H₂S, whereas in the process practiced by Coastal Chem at its Table Rock, Wyo. plant, the ammonia is added to the solution that scrubs SO₂ from a gas stream produced by combusting sulfur or H₂S.

Hydrocarbon Processing (September, 1993) describes processing of an olefin plant's spent caustic solution to convert sulfides in the spent caustic to thiosulfate and elemental sulfur. Hydrocarbon Processing (September, 1993) also describes wet air oxidation of spent caustic where organic constituents are converted to CO₂ and water, and sulfides are converted to thiosulfates or sulfates. Hydrocarbon Processing (September, 1993) also describes partial oxidation to convert about half of the sodium sulfide to sodium sulfate and half to sodium thiosulfate using plant air under a variety of conditions, including 100° C. to 120° C. and 7 to 10 barg, or 175° C. to 250° C. and 14-30 barg. Oil & Gas Journal (Sep. 11, 1988) describes clean-up of tail gas from Claus sulfur recovery units. Processes described produce elemental sulfur using a catalyst, and the reference indicates the production of thiosulfates is undesirable. Oil & Gas Journal (Jan. 2, 1978) describes gas-desulfurization methods involving converting H₂S to elemental sulfur. Oil & Gas Journal (Oct. 20, 1986) describes a process for removing hydrogen sulfide from sour gases and converting it to elemental sulfur. Oil & Gas Journal (Mar. 22, 1982) describes a citrate buffer system to convert SO₂ to elemental sulfur.

There is a need in the art for a process that converts H₂S to a thiosulfate product without producing elemental sulfur, without requiring other components in the solution, such as polyvalent metal ions or chelates that contaminate the thiosulfate product, and which does not require an external combustion oxidizer.

### SUMMARY OF THE INVENTION

In the description herein, it is to be understood that the term “sulfite” refers collectively to both SO₃²⁻ ion and HSO₃⁻ ion, which are in equilibrium in solution in relative concentrations depending upon the pH. It is further understood that “thionates” refers both to thionates and homologs known in the art such as dithionate and trithionate.

Provided is a process for producing a solution comprising thiosulfate ions by partially oxidizing a circulating stream of thiosulfate using oxygen producing a partially oxidized stream comprising thiosulfate and at least one member of the group consisting of thionates, bisulfite and sulfite, adjusting the pH of the partially oxidized stream to between 6 and 8, and contacting the partially oxidized stream with a feed stream comprising sulfide, producing a product stream containing no elemental sulfur.

More particularly, provided is a process for producing a solution of thiosulfate ions by oxidation of one or more reduced sulfur species selected from the group sulfur, hydrogen sulfide (H₂S), bisulfide ion (HS⁻), and sulfide ion (S²⁻), without producing elemental sulfur and without converting more than 9% of the sulfur species to sulfate ion, preferably without converting more than 6% of the sulfur species to sulfate ion, more preferably without converting more than 4% of the sulfur species to sulfate ion comprising:

(a) transferring an original thiosulfate solution to an oxidizer vessel containing one or more oxidizing agents;

(b) partially oxidizing the original thiosulfate solution with one or more oxidizing agents such as air to an intermediate oxidation potential (OP) between the OP of the original thiosulfate solution and that of a reference solution containing the same equivalents of sulfur in the form of sulfite as the original thiosulfate solution, to produce a partially-oxidized stream;

(c) adjusting the pH of the partially oxidized stream to between about 5 and about 8, preferably between 6 and 8;

(d) transferring said partially-oxidized stream to one or more contacting devices wherein said partially-oxidized stream contacts one or more streams containing one or more reduced sulfur species, oxidizing the reduced sulfur species and reducing the partially-oxidized stream, producing a combined stream wherein the ratio of reduced sulfur species to partially-oxidized stream in said contacting device is controlled so that the oxidation potential of the combined stream is the same as that of the original thiosulfate solution under the same conditions of temperature and concentration, producing a thiosulfate stream;

(e) withdrawing a first portion of the product thiosulfate stream as a product thiosulfate stream at a preferred rate equal to the net increase in mass of the reaction, although the rate can be controlled as desired, as known in the art;

(f) recirculating a second portion of the thiosulfate stream to the oxidizer vessel of step (a). In other embodiments, the method further comprises:

(g) controlling the concentration of solutes in the solutions to desired concentrations depending on the desired product, as known in the art. In embodiments where the product stream comprises ATS, the preferred concentrations are about 60% by weight ATS, which is a form in which ATS is commonly marketed, or in the range 75 to 90% ATS, from which anhydrous ATS may be precipitated by cooling; and/or

(h) controlling the temperature of the oxidizer vessel by recirculation of the partially-oxidized stream through a cooler to reenter the oxidizer vessel at one or more points at or below the entry point of thiosulfate solution; and/or

(i) controlling the emission of ammonia and SO₂ from the oxidizer vessel by scrubbing gas vented from the oxidizer vessel with recirculating cooled partially-oxidized stream or original thiosulfate solution. In preferred embodiments, less than 100 ppm SO₂ is produced in the vent gas. In more preferred embodiments, less than 20 ppm SO₂ is produced.

The oxidation potentials of the original thiosulfate solution and the oxidation potential of a reference solution containing the same equivalents of sulfur as the original thiosulfate solution in the form of sulfite, and other oxidation potentials described hereinmay be easily determined as known by one of ordinary skill in the art using standard equipment.

In a preferred embodiment, the method consists essentially of the steps given. In a preferred embodiment, a concentrated solution, containing at least 75% by volume of thiosulfate ions is produced. In a preferred embodiment, the sulfur species in the product thiosulfate stream contains no more than 9% by volume of sulfate ion, more preferably, no more than 6% of the sulfur species is in the form of sulfate ion.

The concentration of solutes in the solutions is controlled by one or more of the temperature of the vent from the oxidizer vent scrubber, the temperature of the vent from the contactor, ratio of oxidizer vent gas to hydrogen sulfide, the ratio of non-condensable vented from the contactor, and addition of water to either oxidizer or product stream, as described further herein.

As used herein, oxidizing agents are those known in the art. A preferred oxidizing agent is a gas stream with an oxygen concentration up to 100%. Oxidizing agents including air, are known in the art. In one embodiment, at least a portion of the oxidizing agent is a stream of vent gas from the oxidation of thiosulfate to sulfite or sulfate. More than one oxidizing agent may be combined or used in separate oxidizer vessels to oxidize separate streams of thiosulfate solution from a common reservoir in the methods of the invention.

As known in the art, more than one reduced sulfur species may be present. Streams containing a reduced sulfur species contain hydrogen sulfide in a preferred embodiment. Other constituents may be present in the stream containing a reduced sulfur species, as known in the art, including carbon dioxide, hydrogen and hydrocarbons. Other constituents may be present at any concentration that does not prevent the desired reaction from occurring.

The stream containing one or more reduced sulfur species may be derived from a variety of processes, including stripping of sour water from a petroleum refinery, coking process, coal or coke gasification, other processes which produces a water stream containing ammonium bisulfide, or other processes that produce a reduced sulfur species, as known in the art. In the embodiment using sour water stripping gas as the stream containing a reduced sulfur species, the rate of circulation of the oxidized solution and the oxidation potential to which it is oxidized are controlled so that the amount of sulfide reacted from the sour water stripper gas is equimolar to the amount of ammonia absorbed from that stream in the contactor and any excess of H₂S is vented from the contacting device. If ammonia is in excess of stoichiometric, H₂S from another source is added to the feed stream or may be absorbed from a stream of gas or immiscible liquid by contacting it in suitable equipment with a stream of partially-oxidized solution, the amount of H₂S absorbed being controlled by the rate of said H₂S-containing stream exposed to such contact to maintain the pH of the thiosulfate solution between 6 and 7.5. In another embodiment, ammonia is added to the liquid stream entering the contacting device to react with the excess H₂S, still capturing thereby the value of the ammonia contained in the feed stream. Sour water stripper gas (SWSG) is typically considered a waste; to prevent emissions to the environment, it is usually incinerated at temperature sufficient to destroy the ammonia. The SO₂ produced is then scrubbed or reacted in downstream equipment to prevent its emission to atmosphere. Ammonia is a valuable commodity in its pure form, but when contaminated with H₂S has little or no commercial value. Chevron has described a process for fractionating the sour water in two successive distillation towers to produce H₂S as a first overhead product to be sent to sulfur recovery by conventional means, ammonia with some H₂S as a second overhead product, and stripped sour water as the bottoms product from the second fractionator. The energy consumed in the process is expensive relative to the low commercial value of the ammonia produced. At the same time, ATS is commonly produced commercially by reacting pure ammonia with SO₂ and H₂S or elemental sulfur. The advantage of the present process is that it converts the ammonia contained in SWSG, which would otherwise be destroyed, into commercially valuable ATS, offering a great advantage in feedstock cost for the production of ATS. In a preferred embodiment, the stream containing a reduced sulfur species includes ammonia, and the ammonia is converted to ammonium thiosulfate without adding supplemental ammonia from a source outside the process.

Also provided is a process for producing one or more of bisulfite or sulfite ions comprising adding a thiosulfate stream to an oxidizer containing an oxidizing agent and oxidizing said thiosulfate stream with the oxidizing agent, preferably air or other oxygen-containing stream, to a working oxidation potential (OP) so that a desired amount, preferably at least 95% of the sulfur in the thiosulfate stream is converted to one or more of bisulfite and sulfite ions. Other amounts of sulfur conversion may be desired in a desired application, and include at least 90%, at least 80% and at least 75% of the sulfur in the thiosulfate stream is converted to one or more of bisulfite and sulfite ions. A working oxidation potential is one that converts the desired amount of sulfur in the thiosulfate stream to sulfite or bisulfite. This working oxidation potential can be determined by one of ordinary skill in the art without undue experimentation, and is generally no higher than that of a reference solution of sulfite at the same concentration and temperature and no lower than the minimum necessary to convert a preferred amount, preferably 95% of the sulfur species in the thiosulfate stream to sulfite or bisulfite. If a preferred embodiment, the working oxidation potential is no more than 10 mV greater and no less than 10 mV less than that of a reference solution of sulfite or bisulfite at the same concentration and temperature. The oxidation potential of a reference solution of sulfite or bisulfite under the same conditions is easily determined by one of ordinary skill in the art without undue experimentation. A preferred working oxidation potential is −225 mV.

Yellowing of thiosulfate solution may occur, as known in the art. Yellowing may be prevented or reduced by controlling the oxidation potential of the product thiosulfate stream to 1-50 mV higher, preferably 10-20 mV higher than the oxidation potential of a solution of thiosulfate ions having the same equivalents of sulfur per volume as the product stream to assure the presence of from 0.1% to 9% of the sulfur in the form of sulfite in the solution, preferably from 0.1% to 6% of the sulfur in the form of sulfite in the solution. The elevation in OP reduces the equilibrium concentration of elemental sulfur in the system so that it does not discolor the solution.

The process hereby disclosed exploits the well-recognized chemistry of sulfur wherein in aqueous solution of pH greater than about 6, ions containing sulfur in oxidation state of +4 oxidize sulfide ion to thiosulfate ion without producing elemental sulfur. All individual pH's, and ranges of pH's, which are effective to produce thiosulfate from the solutions and under the conditions described herein are useful in the invention. The pH may be adjusted as known to one of ordinary skill in the art using conventional means, including addition of chemicals such as an alkaline or alkaline earth oxide, an alkaline or alkaline earth hydroxide, an alkaline or alkaline earth carbonate, aqueous ammonia and ammonia.

The present invention differs from previous methods in producing thiosulfate ion from H₂S or sulfide (S═) ion using either atmospheric oxygen, purified oxygen or other suitable stream containing oxygen as the oxidizer in that the present invention oxidizes the sulfide sulfur to thiosulfate (average oxidation state of sulfur=+2) without production of elemental sulfur that can plug up process equipment. It differs also from the processes disclosed and described in the literature in that the reaction does not require a catalyst or polyvalent metal ions. It differs further in that thiosulfate is a desired product of the reaction, rather than an undesired byproduct to be avoided.

### BRIEF DESCRIPTION OF THE FIGURES

FIG. 1 shows a preferred embodiment of the process of the invention.

FIG. 2 shows an alternative embodiment of the process of the invention.

### DETAILED DESCRIPTION OF THE INVENTION

The disclosed process may be further understood by the following non-limiting examples and description.

Many processes are known that remove H₂S from a gas stream by dissolving the H₂S in a liquid or by reacting the H₂S with an agent such as amine and then conducting the solution to another area of the process where the sulfide is oxidized or driven off by heating. In the present process, because the sulfide converts to thiosulfate as it dissolves, the absorbing solution exhibits negligible vapor pressure of H₂S and can therefore readily reduce the H₂S concentration in the scrubbed stream to very low concentration. It is therefore particularly suitable for treatment of tail gas from a Claus or other primary sulfur recovery unit, known in the art.

In applications of the invention for treatment of tail gas from a Claus or other primary sulfur recovery unit, the present invention has the further advantage that it removes the sulfur in the tail gas from the sulfur recovery process, rather than capturing it to be recycled to the primary recovery process, thereby making capacity available in the latter. By scrubbing the tail gas with the partially oxidized thiosulfate solution, all of the sulfur compounds, as well as elemental sulfur, are converted to thiosulfate with no special control measures. This feature is of great value to petroleum refiners obliged to reduce sulfur in gasoline and diesel and who therefore will need to recover a few tons per day more sulfur than at present.

Sour water stripper gas (SWSG) is typically disposed of by processing in a Claus or similar sulfur recovery unit. To assure destruction of the ammonia to avoid plugging equipment and prevent emission of ammonia to atmosphere, the Claus oxidation step must be operated at a temperature higher than necessary for the oxidation of sulfur. The higher combustion temperature produces more SO₃ and often requires addition of fuel to the oxidation furnace to achieve the necessary temperature. The combustion products of the ammonia, as well as those from any supplementary fuel required, create pressure drop in the sulfur recovery process and dilute the sulfur vapor to be condensed. Therefore, removing one ton of H₂S as SWSG, where it is accompanied by a roughly equimolar amount of ammonia, from the feed to a Claus or similar process frees up capacity in the Claus process for about two and a half tons of H₂S fed as amine-extracted acid gas, reduces operating cost and improves reliability and catalyst life of the Claus. When the process of this invention is used to process the SWSG, it frees up significant amount of Claus capacity and thereby allows the refiner to increase sulfur recovery capacity at a capital cost much lower than by revamp or addition of Claus equipment.

The concentration of sulfite in the scrubber described further hereinmay be maintained low enough by addition of thiosulfate solution to suppress the vapor pressure of SO₂ in equilibrium with the solution so the SO₂ in the vent gas may be reduced to less than 100 ppm, preferably less than 20 ppm.

The present process is less expensive to build and simpler to operate than the Coastal or Haldor Topsoe process. Because it does not conduct oxidation in a flame, it is safer to operate. By performing the oxidation at low temperature, it produces negligible sulfate, whereas the Coastal process inevitably produces some SO₃ in the H₂S burner, resulting in both contaminating the product thiosulfate with sulfate and, because of the difficulty of scrubbing SO₃ from flue gas, more expensive contacting equipment to prevent emission of SO₃ in the flue gas.

Compared to other processes for removal of H₂S from gas streams, the present process is less expensive to build and produces a product that realizes the commercial value of the contained ammonia rather than low-value elemental sulfur or a hazardous waste requiring disposal. Because the H₂S is chemically converted as it is absorbed into the solution, the vapor pressure of H₂S above the solution is nil, making it possible to reduce the concentration of H₂S in the scrubbed solution to a low value, preferably less than 20 ppm with low circulation rates compared to amine scrubbing.

Other sulfur recovery processes based on oxidation of H₂S to sulfur in liquid-phase are prone to plugging with solid sulfur and produce the sulfur in an impure form having low value. Often it must be disposed of as a hazardous waste. Those processes require replacement of the absorption solution as it becomes diluted with soluble sulfur species such as sulfate, sulfite, and thiosulfate, incurring costs for both disposal and replacement of the spent solution. The present process uses no catalyst and preferably all of the species reacting become the thiosulfate product, so there is no liquid or solid waste stream to dispose of. In the present process, elemental sulfur contained in a feed gas, as in tail gas from a Claus unit, is converted to thiosulfate with no extraordinary control actions required, as required by current methods.

Operating at temperatures in the range of 150 to 250 deg F. and not being limited by the solubility of species other than thiosulfate, whose concentrations in the present process are kept below solubility limits by limiting the oxidation potential of the oxidized solution, allows the thiosulfate solution to be produced using only the heat of reaction, and the thiosulfate solution is produced with low concentrations of water, in preferred concentrations of less than 10%. The step used in some competing processes to remove water by evaporating it from the product solution using an outside heat source is obviated.

In the present process, solid thiosulfate may be crystallized from the thiosulfate product by conventional means without addition of heat from an outside source. Preferably, the product thiosulfate stream produced by the methods of the invention contains at least 75% by volume ammonium thiosulfate. In other embodiments, the product thiosulfate stream produced by the methods of the invention contain at least 60% by volume ammonium thiosulfate. The thiosulfate salt solid produced by crystallizing the thiosulfate product has less water of hydration than the salt crystallized from a more dilute solution. Thiosulfate salt with reduced water of hydration is cheaper to transport and resists caking and agglomeration better than the more hydrated salt produced from less concentrated solution. Because it can be applied in the same manner as granular ammonium sulfate fertilizer, solid ammonium thiosulfate (ATS) can compete in markets inaccessible to ammonium thiosulfate solution, which is the usual commercial form of ATS.

The present invention is a less expensive alternative to conventional processes for recovery of sulfur from the tail gas from a Claus or similar process while also eliminating the recycle of tail gas sulfur to the Claus unit and thereby increasing the Claus capacity for fresh H₂S. When an operator of a sulfur recovery system is obliged by regulation to provide redundancy in tail gas treatment, the present process is a relatively inexpensive means to provide that redundancy and its operating cost may result in its becoming the primary process for tail gas treatment while any existing tail gas treatment process would be kept as the standby.

The invention may be better understood by reference to the Figures, where like letters and numbers indicate like components. In the Figures, X (-1, -2, -3) indicate contacting devices, such as venturi contactors, as known in the art. Level controllers (LC) which control the liquid level are used, as known in the art. Valves and other components are used, as conventional in the art. Pumps (P) are also used, as conventional in the art. Heat exchangers (E) may be used as required, to control the temperature of various aspects of the process, as described herein and known in the art. Components such as pumps and heat exchangers may be used at various positions in the process known in the art, not limited to those shown in the Figures.

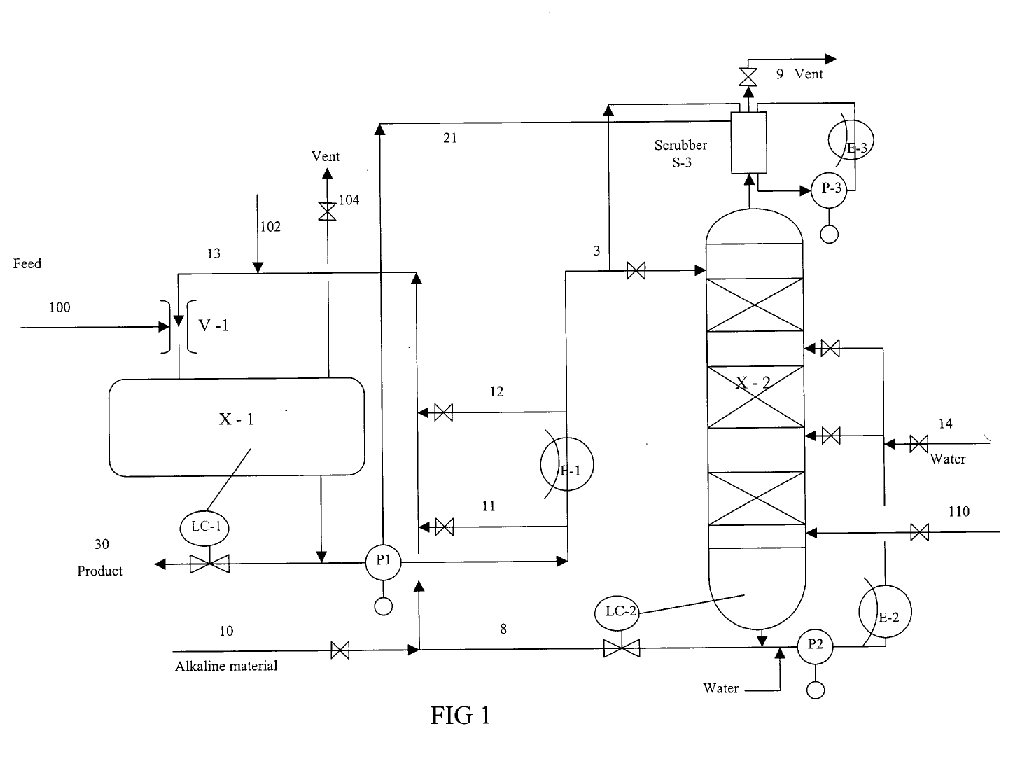

The process shown in FIG. 1 contacts a circulating stream of thiosulfate solution 3 having an oxidation potential of a base value corresponding to that of a product that meets desired specifications for thiosulfate, typically with a weight ratio of (sulfite plus sulfate) to thiosulfate of less than 6%, but can contain a weight ratio of (sulfite plus sulfate) to thiosulfate of 0% to 9% and all intermediate ranges and values therein, with a stream 110 containing oxygen in a contacting device X-2 under conditions controlled to convert a part of the thiosulfate ions to ions in which the average oxidation state of the sulfur is greater than +2 and less than +4. Conditions are controlled to inhibit production of sulfate ions, whose reaction rate with feed sulfide is low and which therefore would accumulate in the circulating solution, requiring a higher circulation rate or contact time than would otherwise be required to oxidize the feed sulfide. The extent of oxidation is controlled by adjusting the temperature in the range 175 to 230 deg F. and pressure in the oxidizing zone to control the oxidation potential of the oxidized solution 8 at a value slightly less than that of sulfite of the same concentration. Stream 110 may have an oxygen concentration up to 100% and an oxygen concentration as low as 5% oxygen and all values and ranges therein. The unreacted oxygen and inert substances, such as nitrogen when air is the oxidizer, are vented from X-2 to scrubber S-3, where it is contacted with thiosulfate solution circulated from S-3 by pump P-3 through heat exchanger E-3. The stream 21 of makeup thiosulfate solution to scrubber S-3 and the heat removal in S-3 are controlled to limit the concentration of ammonia and SO₂ in the gas vented from scrubber S-3 via line 9 for environmental reasons, if desired. The liquid level in S-3 is controlled by allowing it to overflow into X-2. Scrubber S-3 is any conventional scrubber useful to effect mass and heat transfer between liquid and gas, as known in the art. One example is a packed tower. The vent 9 may be to atmosphere because it can be controlled to be essentially free of H₂S or SO₂. The oxidized stream 8, is mixed, if appropriate, with unoxidized solution 11 or 12 to comprise stream 13, then contacts a feed stream 100 containing H₂S and optionally one or more of the following: CO₂, hydrogen, hydrocarbons, SO₂, elemental sulfur, or other gases or liquids practically insoluble in the thiosulfate stream in contacting device V-1. V-1 may be a venturi contactor, packed column, or other conventional device for effecting mass transfer between liquid and gas, chosen on the basis of process design principles familiar to those skilled in the art according to the composition of the feed stream and the desired recovery of the H₂S from it. In X-1 and V-1, the oxidized ions in the oxidized stream 13 react rapidly with the sulfide ion, converting it to thiosulfate. CO₂ is rejected with the gas vented to vent 104. The rate and oxidation potential of the oxidized stream 13 are adjusted so that after contact with the feed stream in V-1 and X-1, the oxidation potential of the solution returns to its base value. These adjustments are known in the art. The extent of reaction of the H₂S from the feed stream may be reduced by specification of the contacting device and by control of the ratio of scrubbing liquid (13) to feed (100). Unreacted components of the feed stream are vented by vent 104 to further processing or to a suitable emission control device such as an incinerator. If the concentration of inert gases in the feed stream is low, a stream of inert gas, such as nitrogen, can be added to the feed stream 100 or introduced to the contacting device V-1 so as to dilute and carry the uncondensed components out vent 104. An alkaline material 10 such as oxides, hydroxides, or carbonates of alkaline or alkaline earth metals, or ammonia, is added to control the pH of the reaction system between 6 and 8. The product stream 30 withdrawn is then a solution of the salt of the alkaline cation and the thiosulfate ion wherein in a preferred embodiment less than 6% of sulfur is present in the form of sulfate plus sulfite and at least 0.5% of the anions are sulfite. All individual values and intermediate concentration ranges are included in the disclosure. Pump P-1 takes suction from X-1 and discharges to the inlet of X-2 and provides circulating streams 11 and 12, whose rates are chosen to satisfy minimum flow requirement for contacting device X-1, temperature control of stream 13, or to control the rejection of a portion of the H₂S contained in the feed stream. Pump P-2 circulates oxidized solution through a cooler to remove the heat of reaction. The temperature of reaction is adjusted to control the rate and products, as known in the art. Heat exchangers E-1 and E-2 remove heat at rates chosen to establish desired temperature profiles in X-1 and X-2, as described herein. Makeup water may be added as required to control solution concentration via line 14, which may enter the process at any convenient point, not limited to the point shown in FIG. 1. Alternatively, and one of the advantages of the invention, the concentration of water in the solution may be reduced to less than 10% by choice of temperature and flow rate of the vent gases from X-1 and X-2, as known in the art. Level controller LC-1 controls the level of liquid in X-1 by moving product from the process to storage through line 30. Level controller LC-2 controls the height of the liquid level in X-2 by sending the excess oxidized product back to X-1.

In one embodiment of the process, the source of H₂S is the gas stream produced by stripping of refinery sour water (SWSG). The SWSG typically contains ammonia, H₂S, and water in roughly equimolar concentrations and may contain other species including cyanide and hydrocarbon. In the disclosed process, the degree of conversion of H₂S in V-1 can be controlled so that the ammonia contained in the SWSG fed to contactor V-1 provides the necessary alkalinity, so that no outside source of alkalinity is necessary. Conditions of pressure, temperature, circulation rate, and oxidation state of the liquid 13 may be adjusted to reject any amount of H₂S in the SWSG in excess of stoichiometric requirements so that it vents via line 104 from X-1, where it may be sent to a Claus or other type of process for recovery, as known in the art. Alternatively, supplemental ammonia may be added via line 102 to enable complete conversion of the sulfur in the SWSG to thiosulfate if the H₂S is in excess of stoichiometric balance with the ammonia in the SWSG. The temperature in X-1 is in any case set higher than the temperature of the vessel in which the SWSG was previously separated from liquid so as to prevent condensation of any hydrocarbon that may be contained in the SWSG. If the process is operated to reject a portion of the H₂S in the feed stream, the vent stream 104 is directed to a sulfur recovery process such as a Claus unit, as known in the art.

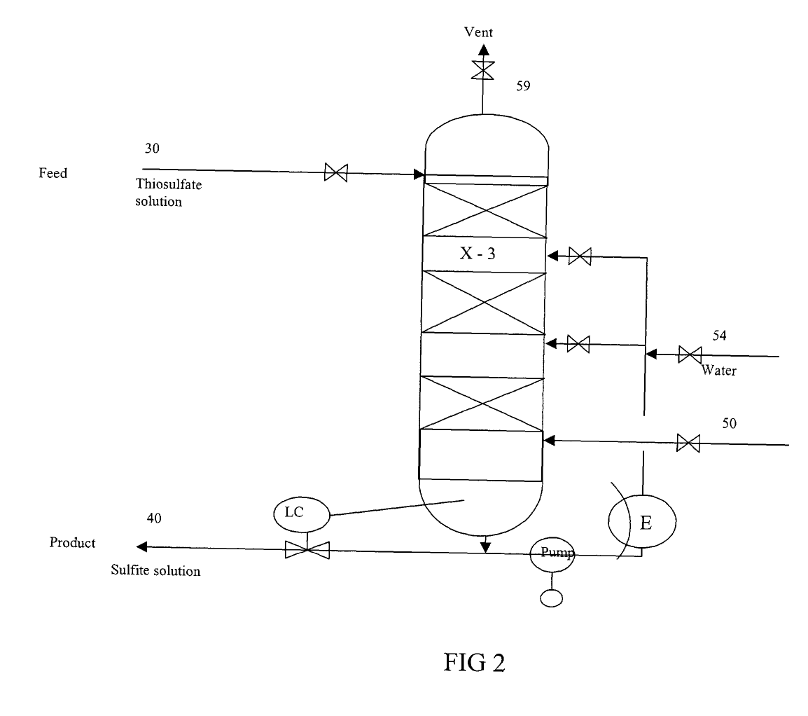

In another variation of the process, shown in FIG. 2, the product stream 30 withdrawn from X-1 is charged to another contacting device X-3, where it contacts a stream of gas containing oxygen (50) under conditions of temperature, pressure, and oxygen concentration to oxidize the thiosulfate ions to thionates or sulfite ions, as described herein and known in the art. The degree of oxidation is controlled to maintain the oxidation potential of the product solution at a value representing the desired concentration of sulfite or bisulfite by modulating the temperature and pressure in X-3, and flow rate of the oxidizing gas 50, as described herein and known in the art. The ratio of alkaline material 10 added in the X-1-X-2 system at any convenient location by conventional means is modulated to control the pH of the product solution 40 to meet specifications for sulfite (SO₃⁼) or bisulfite (HSO₃⁻). The vent gas 59 from contactor X-3 may be used as at least a part of the oxidizing gas 110 to contacting device X-2. The pump shown in FIG. 2 is used to circulate the components of the system. Water 54 may be added if needed to control the concentration of the sulfite product.

In another variation of the process, the oxidized solution 8 from X-2 may be used to remove H₂S from more than one feed stream 100.1, 100.2, etc., (not shown). The feed streams may be from different sources and have different compositions. Where it is desirable to maintain segregation of the feed streams, the oxidized stream 8 may be split into two or more streams 8.1, 8.2, etc. (not shown), each of which contacts one of the feed streams in a separate contacting device X-1.1, X-1.2, etc. (not shown), which may be of different types and may operate at different conditions of temperature and pressure. The rate of oxidized stream to each contacting device is adjusted to control the oxidation potential of the stream leaving each contactor at the desired base value.

In particular, one of the feed streams may be the tail gas from a Claus or other sulfur recovery process so that the present invention may serve as a tail gas treatment process as an alternative to a SCOT or other conventional tail gas treatment process.

In a preferred embodiment of the invention, the feed stream 100 to V-1 is the vent gas from the overhead receiver of a sour water stripper, consisting of approximately equimolar concentrations of H₂S, ammonia, and water vapor, and may contain traces of hydrocarbons, hydrogen cyanide and some CO₂, at about 5 psig and 180 deg F. Normally, water is withdrawn from the overhead receiver of the sour water stripper at a rate sufficient to prevent concentration of the cyanide to where it becomes significant to the present process. When necessary, however, the cyanide can be removed from the feed gas by scrubbing with a dilute caustic solution, converting the cyanide to non-volatile thiocyanate. X-1 is operated at a temperature higher (about 10 def F higher in a preferred embodiment) than the receiver of the sour water stripper so that no hydrocarbon in the feed stream condenses in X-1, typically 180-200 deg F., preferably about 5 psig and 180 deg F. If the concentration of non-condensable in the feed gas is negligible, a small stream of nitrogen may be added to V-1 to continuously purge the hydrocarbon from the system to vent to an incinerator or other desired means of disposal, as known in the art. In the preferred embodiment, the contacting device of choice is a venturi contactor V-1, facilitating control of the rejection, if necessary, of any small stoichiometric excess of H₂S over ammonia in the feed. Alternatively, ammonia from an external source may be added to the liquid stream entering V-1 to match the excess of H₂S so that essentially all of the H₂S may be reacted in X-1, reducing the concentration of H₂S in the vent stream to less than a hundred ppm. The rates of recycle streams 11 and 12 are set to control the temperature and flow rate of liquid to X-1. In a preferred embodiment, X-2 is operated at 185-225 deg F. and about 15 to 50 psig to oxidize the circulating thiosulfate stream so that its oxidation potential corresponds to about 25 to 50% conversion of thiosulfate to sulfite, the molar flow of oxidant to X-1 balances the amount required to oxidize the H₂S in the feed to elemental S. The ammonium thiosulfate product is withdrawn from the reservoir X-1 on level control thereof to mass-balance the system.

In a preferred embodiment, the flow of thiosulfate solution to scrubber S-3 is set at about 5% of the flow to X-2. Excess liquid from scrubber S-3 is drained on level control to the top packing of X-2. X-2 operates at 30 psig and about 185 deg F., controlled by backpressure control on the vent from the scrubber S-3 and by circulation of liquid through cooler E-2 and back to each level of X-2 at rates adjusted to produce a roughly constant temperature profile in X-2. Air rate is set at 125% of stoichiometric demand. Level control LC-2 modulates the flow of oxidized solution returning to X-1. The flow rate of air is modulated to control the extent of oxidation of the circulating solution so that the oxidation potential of the thiosulfate solution in X-1 remains constant at about −350 mV. The ORP of the solution from X-2 is about −250 mV. Level control of V-1 modulates the flow of product to storage drawn from the discharge of pump P-1. Water is added to X-2 so that the concentration of water in the thiosulfate product is about 38-40%.

Alternatively, no water is added to the process loop, allowing the solution to concentrate to less than 15% water. A stream of solution from P-1 is directed to conventional equipment, such as flash cooling and solid/liquid separation equipment to crystallize and separate solid anhydrous ammonium thiosulfate. A portion of the mother liquor is returned to X-1 and the rest is directed to storage as product.

In the preferred embodiment using sour water stripper gas from a petroleum refinery, X-1 and X-2 are charged with ammonium thiosulfate to establish baseline levels. Air is used to pressure X-2 to about 25 psig. The ammonium thiosulfate is then circulated through the reactors and heated by means of steam in E-1 and E-2 to about 185 degrees F. Air is introduced into X-2 building a pressure in the X-2 to 25-100 pounds gauge (psig). The process is exothermic and the heat of reaction will provide all heat required after the oxidation reaction has been initiated in X-2 to sustain the reaction. The ORP of the circulating solution in X-2 will climb from approximately −368 mV to −220 to −250 mV as the solution increases in oxidation state. The solution is circulated through the contacting areas through the recycle line that run through heat exchanger E-2. Heat exchanger E-2 removes a portion of the heat of reaction and is used to control the temperature of the recycle in the range of 185-230 degrees F. to maintain the ability to oxidize the solution and to prevent the oxidation reaction from going to the sulfate. A portion of this oxidized solution from X-2 is circulated through line 8 back to contacting device V-1 where the solution is contacted with the sour water stripper gas.

The stream of oxidized solution coming from X-2 via line 8 may be combined with a recycle stream from X-1 to aid in the contacting of the reducing stream and to provide the velocities required if the contacting device V-1 is a venturi. The sour water stripper gas entering the contacting device reduces the circulating stream back to the original ORP. The reaction in X-1 is also slightly exothermic and the temperature of the stream entering X-1 is controlled by E-1 and the amount or recycle through lines 11 and 12. Other means of direct heat transfer familiar to one of ordinary skill in the art may be used.

Reactor X-1 operates at a lower pressure, preferably in the range of 5-10 pounds gauge. As the reducing stream is reacted additional product is produced. This additional product is removed from the system by LC-1 controlling the volume in X-1.

Although the description above contains many specificities, these should not be construed as limiting the scope of the invention, but as merely providing illustrations of some of the preferred embodiments of the invention. For example, conditions other than those described herein may be used, as long as the desired reactions occur at acceptable rates with the desired selectivity. All references cited herein are incorporated by reference to the extent not inconsistent with the disclosure herewith.

We claim:

1. A process for producing thiosulfate ions by oxidation of one or more reduced sulfur species selected from the group consisting of: hydrogen sulfide, bisulfide ion and sulfide ion without producing elemental sulfur and without converting more than 6% of the sulfur species to sulfate ion, comprising:
(a) transferring an original thiosulfate solution to an oxidizer vessel containing one or more oxidizing agents;
(b) partially oxidizing the original thiosulfate solution with one or more oxidizing agents to an intermediate oxidation potential (OP) between the OP of the original thiosulfate solution and that of a reference solution containing the same equivalents of sulfur in the form of sulfite as the original thiosulfate solution, to produce a partially-oxidized stream;
(c) adjusting the pH of the partially-oxidized stream to between 5 and 8;
(d) transferring said partially-oxidized stream to one or more contacting devices wherein said partially-oxidized stream contacts one or more streams containing one or more reduced sulfur species, oxidizing the reduced sulfur species and reducing the partially-oxidized stream, producing a combined stream, wherein the ratio of reduced sulfur species to partially-oxidized stream in said contacting devices is controlled so that the oxidation potential of the combined stream is the same as that of the original thiosulfate solution under the same conditions, producing a product thiosulfate stream;
(e) withdrawing a first portion of the product thiosulfate stream corresponding to the net increase in mass of the reaction in step (b);
(f) recirculating a second portion of the product thiosulfate stream to the oxidizer vessel of step (a);
(g) diverting a portion of the thiosulfate solution being recirculated to the oxidizer vessel to a scrubber wherein gas from the oxidizer vessel is scrubbed and the temperature of the scrubber is controlled, and transferring the scrubber solution from the scrubber to the oxidizer vessel.

2. A process for producing one or more of bisulfite and sulfite ions comprising:
adding a thiosulfate stream to an oxidizer containing an oxidizing agent; oxidizing said thiosulfate stream with the oxidizing agent to a working oxidation potential so that at least 95% of the sulfur in the thiosulfate stream is converted to one or more of bisulfite and sulfite ions.

3. The process of claim 1, wherein the oxidizing agent is oxygen in concentrations up to 100%.

4. The process of claim 2, wherein the oxidizing agent is oxygen in concentrations up to 100%.

5. The process of claim 1, wherein the oxidizing agent is air.

6. The process of claim 2, wherein the oxidizing agent is air.

7. The process of claim 2, wherein the working oxidation potential is about −225 mV.

8. The process of claim 1, wherein the pH is adjusted by addition of a member of the group selected from: an alkaline or alkaline earth oxide, an alkaline or alkaline earth hydroxide, an alkaline or alkaline earth carbonate, aqueous ammonia and ammonia.

9. The process of claim 1 wherein the stream containing a reduced sulfur species further comprises ammonia, and wherein the product thiosulfate stream comprises ammonium thiosulfate.

10. A process for producing anhydrous ammonium thiosulfate having a water concentration less than 25% comprising: crystallizing the product thiosulfate stream produced by claim 1.

11. The process of claim 1, wherein the stream containing a reduced sulfur species also contains a member of the group consisting of: carbon dioxide, hydrogen and hydrocarbons.

12. The process of claim 1 wherein at least one of the streams containing a reduced sulfur species is the tail gas stream from a process for converting hydrogen sulfide to elemental sulfur.

13. The process of claim 1, further comprising controlling the temperature and oxidation potential of the solution in the scrubber, whereby vent gas from the scrubber contains less than 100 ppm SO₂.

14. The process of claim 1, wherein a stream containing a reduced sulfur species is a gas or liquid stream comprising H₂S which is immiscible with the partially-oxidized stream, and the product thiosulfate stream is withdrawn by separating the product thiosulfate stream from the immiscible stream.

15. A method for oxidizing sulfide without producing elemental sulfur comprising:
a) partially oxidizing a circulating stream of thiosulfate using oxygen, producing a partially oxidized stream comprising thiosulfate, and at least one member of the group consisting of: thionates, bisulfite and sulfite;
b) adjusting the pH of the partially oxidized stream to between about 6 and 8; and
c) contacting the partially oxidized stream with a feed stream comprising sulfide, whereby a product stream containing no elemental sulfur is produced.

16. The method of claim 15, wherein the pH is adjusted using a member of the group selected from: an alkaline or alkaline earth oxide, an alkaline or alkaline earth hydroxide, an alkaline or alkaline earth carbonate, aqueous ammonia and ammonia.

17. The method of claim 15, further comprising contacting the product stream with an oxygen-containing stream, whereby the thiosulfate stream is oxidized to a working oxidation potential so that at least 95% of the sulfur in the thiosulfate stream is converted to one or more members of the group consisting of: bisulfite and sulfite ions.

18. The method of claim 17, wherein the oxygen-containing stream is air.

19. The method of claim 15, wherein the feed stream further comprises a member of the group consisting of: carbon dioxide, hydrogen and hydrocarbons.

20. The method of claim 15, wherein the feed stream further comprises ammonia.
